(19) United States
(12) Patent Application Publication
(10) Pub. No.: US 2016/0325411 A1
(43) Pub. Date: Nov. 10, 2016

(54) Tool Bit

(71) Applicant: Tzu-Chien Wang, Tainan City (TW)

(72) Inventor: Tzu-Chien Wang, Tainan City (TW)

(73) Assignee: Compass Corp., Tainan City (TW)

(21) Appl. No.: 14/708,189

(22) Filed: May 9, 2015

(51) Int. Cl. B25B 15/00

(52) U.S. Cl. CPC B25B 15/001

(57) ABSTRACT

A tool bit includes a front end having an insertion section. The tool bit further includes an extension behind the insertion section along a longitudinal axis and a clamping section behind the extension along the longitudinal axis. The insertion section includes a front end having an insertion end. The insertion end can be coupled with a head of a screw. The clamping section can be coupled with a rotating tool. The extension has circular cross sections and has a diameter smaller than an outer diameter of the insertion section. The extension includes at least two flanges spaced from each other along the longitudinal axis. An annular groove is defined between two adjacent flanges, is in a smaller torsional strength area of the extension, and has a torsional strength larger than a torsional strength of the insertion end.

### BACKGROUND OF THE INVENTION

The present invention relates to a tool bit and, more particularly, to a tool bit capable of distributing the stress to prolong the service life.

Tool bits are generally produced by processing metal. FIG. 6 shows a conventional tool bit 1′ in the form of an elongated body. The tool bit 1′ includes a front end having an insertion section 11′. The tool bit 1′ further includes a cylindrical extension 12′ behind the insertion section 11′ and a clamping section 13′ behind the extension 12′. The clamping section 13′ can be coupled with a rotating tool 3′ that can be driven manually, pneumatically, or electrically. The insertion section 11′ includes a front end having an insertion end 111′ for coupling with a slot 21′ in a head of a screw 2′. The insertion end 111′ is a cabinet tip, a Phillips head top, or polygonal. The extension 12′ prevent the rotating tool 3′ from becoming too close to the screw 2′ when the tool bit 1′ is engaged and jointly rotates with the screw 2′, permitting tightening operation of the screw 2′.

When the rotating tool 3′ rotates, the torque applied by the rotating tool 3′ is transmitted through the tool bit 1′ to the screw 2′ for tightening an object 4′. During tightening of the screw 2′, the insertion section 11′ engaged with the screw 2′ bears the biggest part of the reactive stress of the torque. Although the extension 12′ and the clamping section 13′ can transmit a portion of the stress, the stress mainly concentrates in the insertion section 11′, such that the insertion end 111′ of the insertion section 11′ is apt to deform or even break, resulting in frequent replacement of the bit 1′.

FIG. 7 is a diagram illustrating a torque test result of the conventional tool bit. A torsion angle of 35.257 degrees occurred when the tool bit 1′ was subject to a torque of 201.05 kg/cm, resulting in deformation and damage of the insertion end 111′.

### BRIEF SUMMARY OF THE INVENTION

An objective of the present invention is to provide a tool bit capable of distributing the stress to prolong the service life.

A tool bit according to the present invention includes a front end having an insertion section. The tool bit further includes an extension behind the insertion section along a longitudinal axis and a clamping section behind the extension along the longitudinal axis. The insertion section includes a front end having an insertion end. The insertion end is adapted to couple with a head of a screw. The clamping section is adapted to couple with a rotating tool. The extension has circular cross sections and has a diameter smaller than an outer diameter of the insertion section. The extension includes at least two flanges spaced from each other along the longitudinal axis. An annular groove is defined between two adjacent flanges, is in a smaller torsional strength area of the extension, and has a torsional strength larger than a torsional strength of the insertion end.

Each of the at least two flanges can include an outer peripheral face surrounding and coaxial to the longitudinal axis. The outer peripheral face of each of the at least two flanges includes two peripheral edges spaced from each other along the longitudinal axis. A conical face extends from each of the two peripheral edges of the outer peripheral face towards the longitudinal axis and is at an obtuse angle to the outer peripheral face. Each conical face includes an inner edge. An inner peripheral face extends from the inner edge of each conical face, surrounds and is coaxial to the longitudinal axis, and is located in the annular groove. The inner peripheral face is at an obtuse angle to the conical face.

The tool bit can further include a conical section between the extension and the insertion section. The conical section has increasing diameters towards the insertion section.

The insertion end can be a Phillips head top, a cabinet tip, plum-shaped, or polygonal.

The clamping section can be a substantially hexagonal rod.

The present invention will become clearer in light of the following detailed description of illustrative embodiments of this invention described in connection with the drawings.

### DESCRIPTION OF THE DRAWINGS

FIG. 1 is a perspective view of a tool bit according to the present invention.

FIG. 2 is a side elevational view of the tool bit according to the present invention.

FIG. 3 is a partial, cross sectional view of the tool bit according to the present invention.

FIG. 4 is a diagrammatic view illustrating tightening a screw by the tool bit according to the present invention.

FIG. 5 is a diagram illustrating a torque test result of the tool bit according to the present invention.

FIG. 6 is a diagrammatic view illustrating a conventional tool bit for tightening a screw 2′.

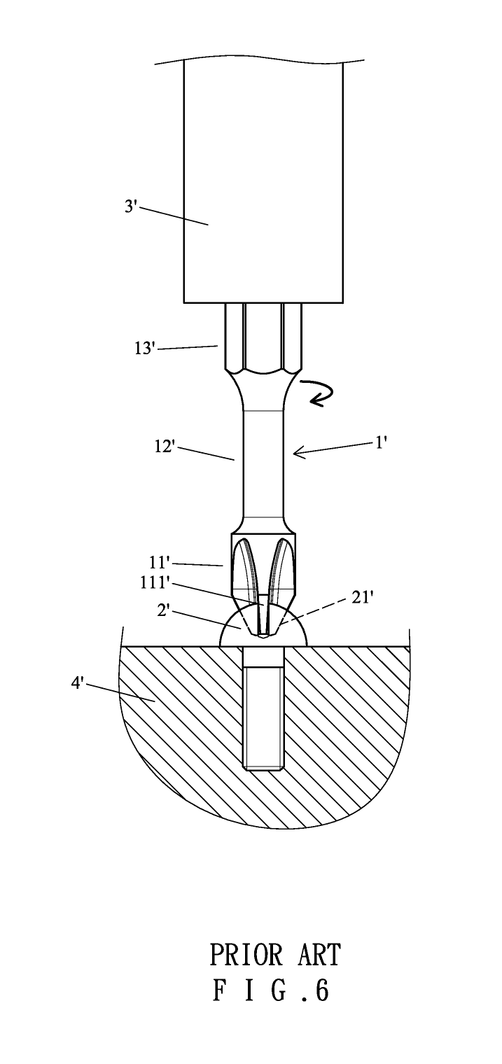

FIG. 7 is a diagram illustrating a torque test result of the conventional tool bit.

### DETAILED DESCRIPTION OF THE INVENTION

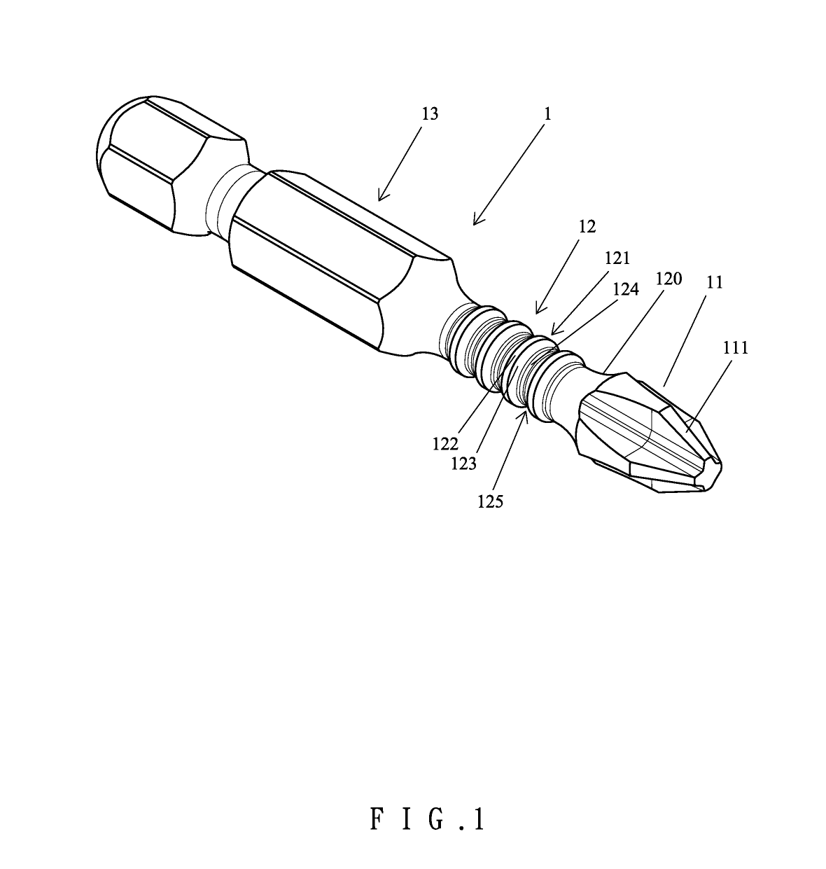

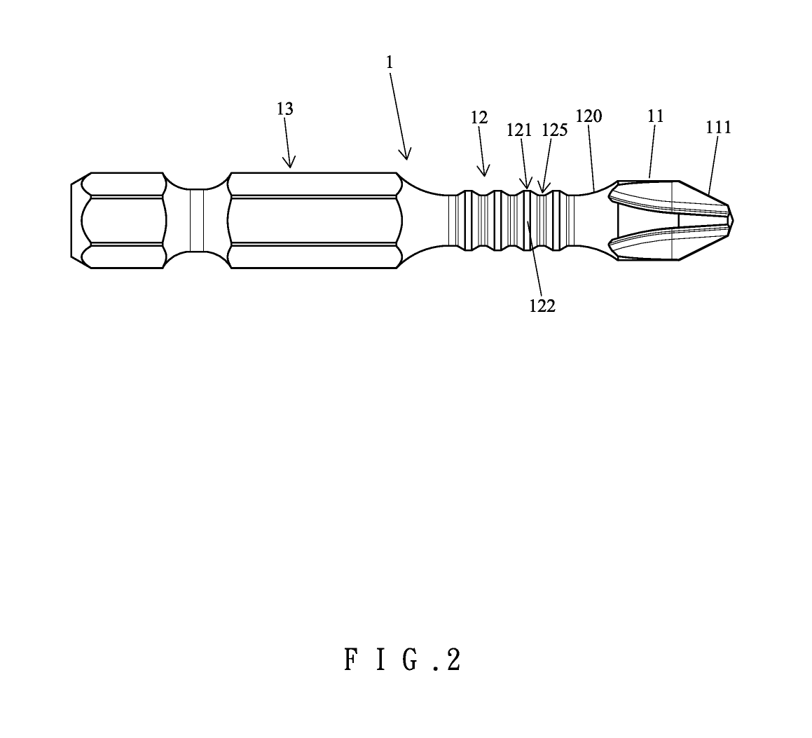

With reference to FIGS. 1 and 2, a tool bit 1 according to the present invention is produced by processing a metal material to form a substantially elongated body. The tool bit 1 includes a front end having an insertion section 11. The tool bit further includes an extension 12 behind the insertion section 11 along a longitudinal axis and a clamping section 13 behind the extension 12 along the longitudinal axis. The insertion section 11 includes a front end having an insertion end 111. The insertion end 111 is adapted to couple with a slot 21 in a head of a screw 2. The insertion end 111 is a Phillips head top, a cabinet tip, plum-shaped, or polygonal. In the form shown, the insertion end 111 is a Philips head tip. The clamping section 13 is adapted to couple with a rotating tool 3 and is a substantially hexagonal rod.

The extension 12 has circular cross sections and has a diameter smaller than an outer diameter of the insertion section 11. A conical section 120 is formed between the extension 12 and the insertion section 11. The conical section 120 has increasing diameters towards the insertion section 11. Furthermore, the extension 12 includes at least two flanges 121 (four flanges 121 in this embodiment) spaced from each other along the longitudinal axis. Each flange 121 includes an outer peripheral face 122 surrounding and coaxial to the longitudinal axis. The outer peripheral face 122 of each flange 121 includes two peripheral edges spaced from each other along the longitudinal axis. A conical face 123 extends from each of the two peripheral edges of the outer peripheral face 122 towards the longitudinal axis and is at an obtuse angle A to the outer peripheral face 122. Each conical face 123 includes an inner edge. An inner peripheral face 124 extends from the inner edge of each conical face 123, surrounds the longitudinal axis, and is coaxial to the longitudinal axis. The inner peripheral face 124 is at an obtuse angle B to the conical face 123. An annular groove 125 is defined between two adjacent flanges 121. Each annular groove 125 is in a smaller torsional strength area of the extension 12. A torsional strength of each annular groove 125 is larger than a torsional strength of the insertion end 111. Each inner peripheral face 124 is located in a corresponding annular groove 125.

Since the diameter of the extension 12 is smaller than the outer diameter of the insertion section 11, the weight and material costs of the tool bit 1 can be reduced. Furthermore, the outer peripheral faces 122 coaxial to the longitudinal axis, the inner peripheral faces 124 coaxial to the longitudinal axis, and the conical faces 123 can easily be processed by milling

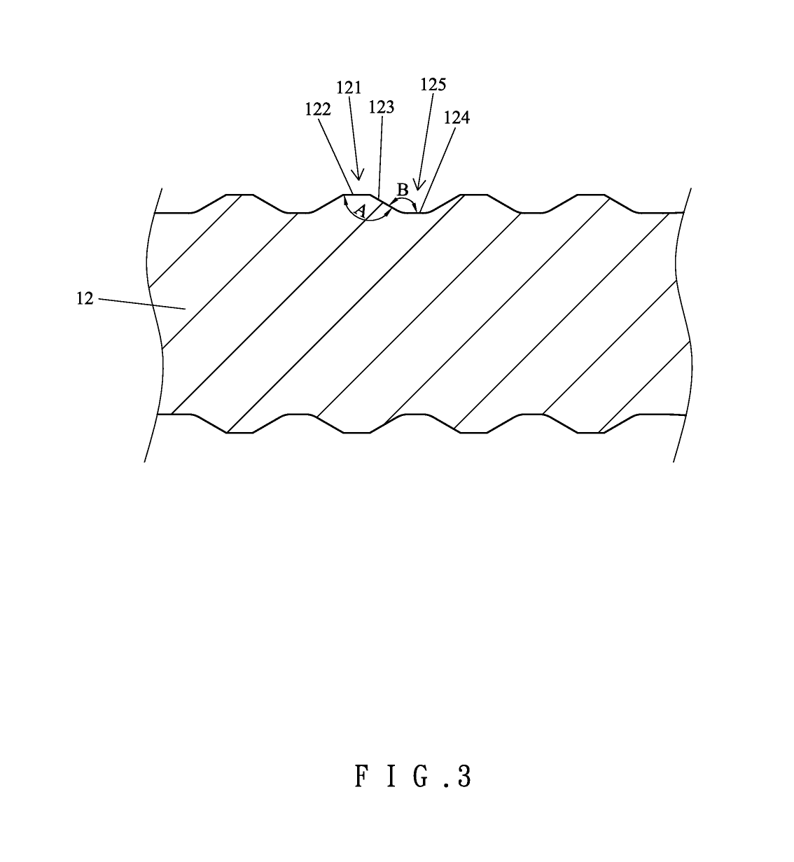

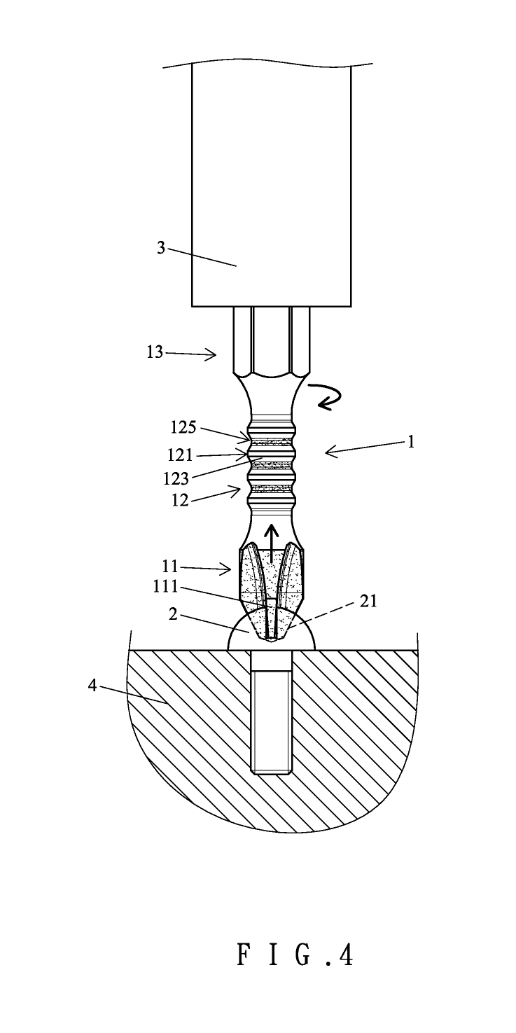

With reference to FIGS. 3 and 4, in use, the clamping section 13 of the tool bit 1 is coupled with a rotating tool 3 that can be rotated manually, electrically, or pneumatically. The insertion end 111 of the insertion section 11 is inserted into the slot 21 of the screw 2. The rotating tool 3 is actuated to rotate the tool bit 1 to generate a torque, tightening the screw 2 to the object 4. During tightening of the screw 2, the reactive stress (see the dots in insertion section 11) generated by the insertion section 11 of the tool bit 1 is transmitted to the central portion of the extension 12 via the conical portion 120. This portion of stress can be distributed to an inner portion of each annular groove 125 located in the smaller torsional strength area of the extension 12. The circular cross sections of the extension 12 permit uniform stress distribution in different angular positions. Furthermore, the conical faces 123 of the extension 12 permit the stress to be transmitted to the inner portion of each annular groove 125 along the longitudinal axis (see the dots in each annular groove 125). Furthermore, due to provision of the obtuse angle A (not perpendicular or acute angle) between the conical face 123 and the outer peripheral face 122 and the obtuse angle B (not perpendicular or acute angle) between the conical face 123 and the inner peripheral face 124, stress concentration in corners and potential breakage can be avoided. Furthermore, although each annular groove 125 is in the smaller torsional strength area of the extension 12, the torsional strength of each annular groove 125 is still larger than that of the insertion end 111 to avoid reduction in the service life of the tool bit 1.

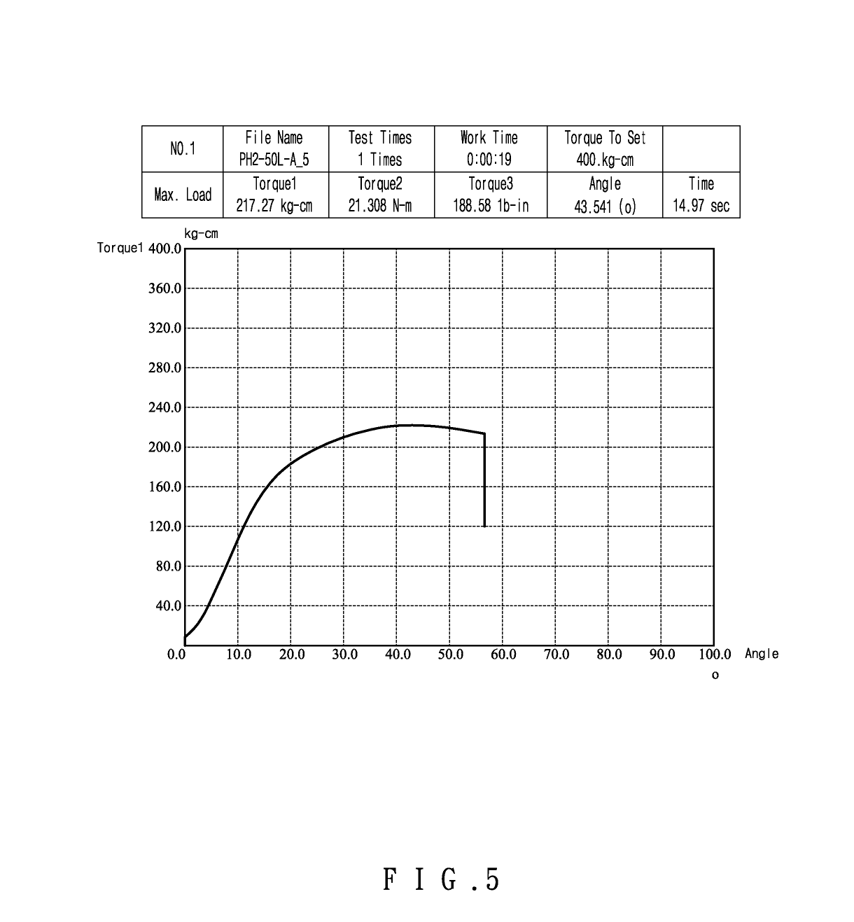

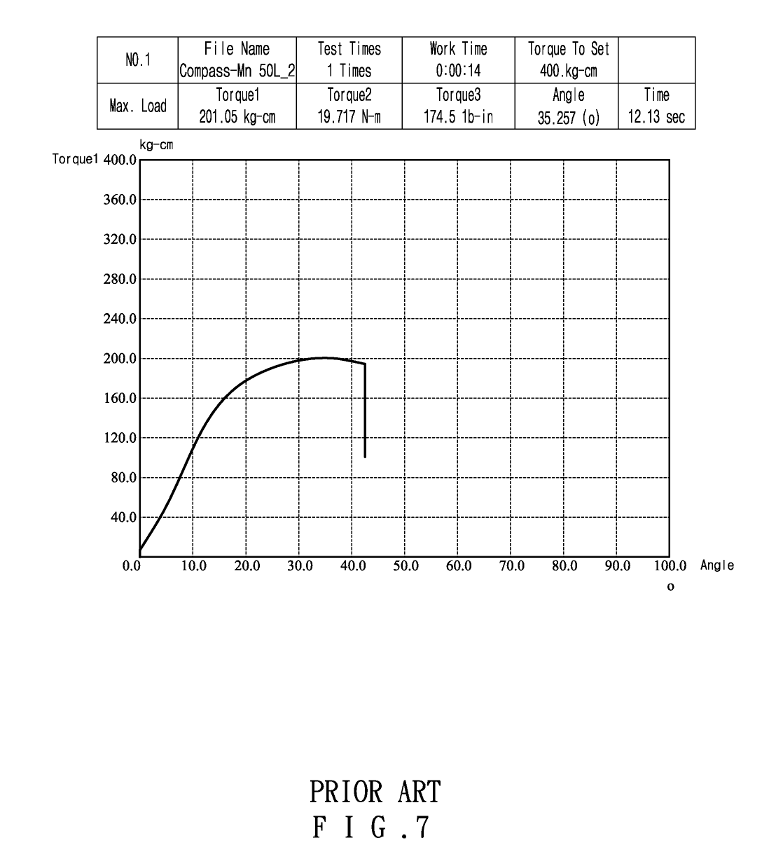

FIG. 5 is a diagram illustrating a torque test result of the tool bit 1 according to the present invention. The tool bit 1 is made of an alloy steel material the same as that of the conventional tool bit 1′ whose torque test result is shown in FIG. 7. As shown in FIG. 5, a torsion angle of 43.541 degrees occurred when the tool bit 1 according to the present invention was subject to a torque of 217.27 kg/cm, and the insertion end 111 was damaged. The torsional strength of 217.27 kg/cm of the tool bit 1 according to the present invention is better than the torsional strength (201.05 kg/cm) of the conventional tool bit 1′. Thus, the tool bit 1 according to the present invention can prevent excessive stress concentration on the insertion section 11 by providing the extension 12. Furthermore, the torsional strength of the tool bit 1 is increased to reduce the risk of deformation or breakage of the insertion end 111, increasing the service life of the tool bit 1. The number of the flanges 121 of the extension 12 of the tool bit 1 according to the present invention can be varied according to the length of the extension 12. Namely, two or more flanges 121 can be provided to form one or more annular grooves 125.

Although specific embodiments have been illustrated and described, numerous modifications and variations are still possible without departing from the scope of the invention. The scope of the invention is limited by the accompanying claims.

1. A tool bit comprising a front end having an insertion section, with the tool bit further comprising an extension behind the insertion section along a longitudinal axis and a clamping section behind the extension along the longitudinal axis, with the insertion section including a front end having an insertion end, with the insertion end adapted to couple with a head of a screw, with the clamping section adapted to couple with a rotating tool, with the extension having circular cross sections and having a diameter smaller than an outer diameter of the insertion section, with the extension including at least two flanges spaced from each other along the longitudinal axis, with an annular groove defined between two adjacent flanges, with the annular groove being in a smaller torsional strength area of the extension, and with a torsional strength of the annular groove larger than a torsional strength of the insertion end.

2. The tool bit as claimed in claim 1, with each of the at least two flanges including an outer peripheral face surrounding and coaxial to the longitudinal axis, with the outer peripheral face of each of the at least two flanges including two peripheral edges spaced from each other along the longitudinal axis, with a conical face extending from each of the two peripheral edges of the outer peripheral face towards the longitudinal axis and at an obtuse angle to the outer peripheral face, with each conical face including an inner edge, with an inner peripheral face extending from the inner edge of each conical face, surrounding and coaxial to the longitudinal axis, and located in the annular groove, and with the inner peripheral face being at an obtuse angle to the conical face.

3. The tool bit as claimed in claim 1, further comprising a conical section between the extension and the insertion section, with the conical section having increasing diameters towards the insertion section.

4. The tool bit as claimed in claim 3, wherein the insertion end is a Phillips head top, a cabinet tip, plum-shaped, or polygonal.

5. The tool bit as claimed in claim 1, wherein the clamping section is a substantially hexagonal rod.
